(19) United States
(12) Patent Application Publication
(10) Pub. No.: US 2010/0022279 A1
(43) Pub. Date: Jan. 28, 2010

(54) MOOD DEPENDENT ALERT SIGNALS IN COMMUNICATION DEVICES

(75) Inventors: Johan Hoberg, Malmo (SE); Magnus Hellfalk, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 12/177,297

(22) Filed: Jul. 22, 2008

(51) Int. Cl. H04B 1/38

(52) U.S. Cl. 455/567

(57) ABSTRACT

The invention relates to a method for creating a unique communication signal in a communication device, comprising the steps of receiving an incoming communication event, acquiring user specific parameters, creating a unique communication signal based on the user specific parameters and the communication event, executing the unique communication signal to alert the user of the incoming event.

### TECHNICAL FIELD

The present invention relates to the field of mobile communication devices and, in particularly, to the creation of unique mood dependent signals which may be used, for example, as ringtones or be included in different messaging applications such as in a Multimedia Message Service (MMS).

### BACKGROUND

Mobile communication devices, such as mobile phones, have become one of the most important tools for communicating between people. The number of ways a user may communicate and express himself/herself to another user(s) using a mobile phone have steadily increased, and for many people the phone has become more or less an extension of the their own self. Due to the fact that the mobile communication device plays such an integral part in people's life, it has become important to be able to accessorize and customize the mobile communication device to express and to communicate an opinion, a mood, or social status to other users.

Today there are several ways to customize the appearance of a mobile communication device. The outer shell of a mobile communication device may be replaced, ringtones and themes may be downloaded and/or modified to better suite the user's mood and preferences. However, many times the selection of for example ringtones are quite limited, and therefore the user may not be able to communicate his or hers mood to other users. Also, making changes such as altering the ringtone or changing the appearance of the mobile communication device is often a cumbersome and tedious process resulting in that the user don't bother to make these changes since it consumes too much time.

Therefore, finding a way too easily and effortless change certain parameters, such as the ringtone, of the mobile communication device to better reflect a user's current mood, and to communicating that mood to other users would be much coveted.

### SUMMARY OF THE INVENTION

With the above and following description in mind, then, an aspect of the present invention is to provide a method for making mood dependent changes to a communication device which seeks to mitigate, alleviate, or eliminate one or more of the above-identified deficiencies in the art and disadvantages singly or in any combination.

A first aspect of the present invention relates to a method for creating a unique communication signal in a communication device, comprising the steps of receiving an incoming communication event, acquiring user specific parameters, creating a unique communication signal based on said user specific parameters and said communication event, executing said unique communication signal to alert the user of the incoming event.

The method may also comprise that said communication event is an incoming voice call.

The method may also comprise that said communication event is any communication event of the group comprising: incoming Short Message Service (SMS) event, incoming Multimedia Message Service (MMS) event, incoming e-mail event, incoming Bluetooth communication event, incoming near field communication event, incoming instant messenger event, and incoming data event.

The method may also comprise that said user specific parameters are user-inputted parameters defining the mood of the user.

The method may also comprise that said user specific parameters are any parameters of the group comprising: parameters describing the user's physical state, parameters describing the user's mental state, parameters describing the user's activity level, and parameters coming from an application in the communication device.

The method may also comprise that said unique communication signal is a ringtone.

The method may also comprise that said unique communication signal is an audio signal.

The method may also comprise that said creation of said unique communications signal is further based on parameters from a SenseMe application and audio signals from a MusicDJ application.

The method may also comprise that said executing involve playing said ringtone to the user.

The method may also comprise that said executing involve playing said audio signal to the user.

The method may also comprise that said executing further involves attaching said unique communication signal to an application in said communication device.

A second aspect of the present invention relates to a method for creating a unique communication signal in a communication device, comprising the steps of, initiating an outgoing communication event, acquiring user specific parameters, creating a unique communications signal based on said user specific parameters and said outgoing communication event, providing said outgoing communication event with the unique communication signal, transmitting said outgoing communication event and the unique communication signal, and the communication signal is adapted to be executed for alerting a recipient of the transmitted the outgoing communication event.

The method may also comprise that said outgoing communication event is an outgoing Multimedia Message Service event.

The method may also comprise that said outgoing communication event is any communication event of the group comprising: outgoing Short Message Service event, outgoing e-mail event, outgoing Bluetooth communication event, outgoing near field communication event, outgoing instant messenger event, and outgoing data event.

The method may also comprise that said user specific parameters are any parameters of the group comprising: parameters describing the user's physical state, parameters describing the user's mental state, parameters describing the user's activity level, and parameters coming from an application in the communication device.

The method may also comprise that said creation of said unique communications signal is further based on parameters from a SenseMe application and audio signals from a MusicDJ application.

The method may also comprise that said unique communication signal is an audio signal.

The method may also comprise that said outgoing communication event is an outgoing Multimedia Message Service event.

The method may also comprise that said outgoing communication event is any of the outgoing communication events of the group comprising: outgoing Short Message Service event, outgoing e-mail event, outgoing Bluetooth communication event, outgoing near field communication event, outgoing instant messenger event, and outgoing data event.

The method may also comprise that said transmitting involves communicating wirelessly or by wire with a recipient.

The method may also comprise that said recipient is any recipient of the group comprising: a user of a mobile communication device, a group of users of mobile communication devices, and a computer terminal.

A third aspect of the present invention relates to a communication device adapted to perform the steps of the above methods.
Any of the features in the first, second, and third aspect of the present invention above may be combined in any way possible.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows a mobile communication device, in this case a mobile phone, according to an embodiment of the present invention; and

FIG. 2 shows a flowchart describing a process for creating a mood dependent signal according to an embodiment of the present invention; and

FIG. 3 shows a flowchart describing a user-case of the process, described in conjunction with FIG. 2, for creating a mood dependent signal according to an embodiment of the present invention; and

FIG. 4 shows another flowchart describing a process for creating a mood dependent signal according to an embodiment of the present invention; and

FIG. 5 shows a flowchart describing a user-case of the process, described in conjunction with FIG. 4, for creating a mood dependent signal according to an embodiment of the present invention; and

FIG. 6 shows an display view according to and embodiment of the present invention; and

FIG. 7 shows a group of mobile communication device communicating with each other and a database via base station according to an embodiment of the present invention; and

FIG. 8 shows different means in a communication device for performing the tasks associated with the embodiments of the present invention.

### DETAILED DESCRIPTION

Embodiments of the present invention relate, in general, to the field of mobile communication devices and, in particularly, to the creation of unique mood dependent signals which may be used to communicate the mood of a user to other users.

A preferred embodiment relates to a portable communication device, such as a mobile phone, including one or more marker input devices. However, it should be appreciated that the invention is as such equally applicable to electronic devices which do not include any radio communication capabilities. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

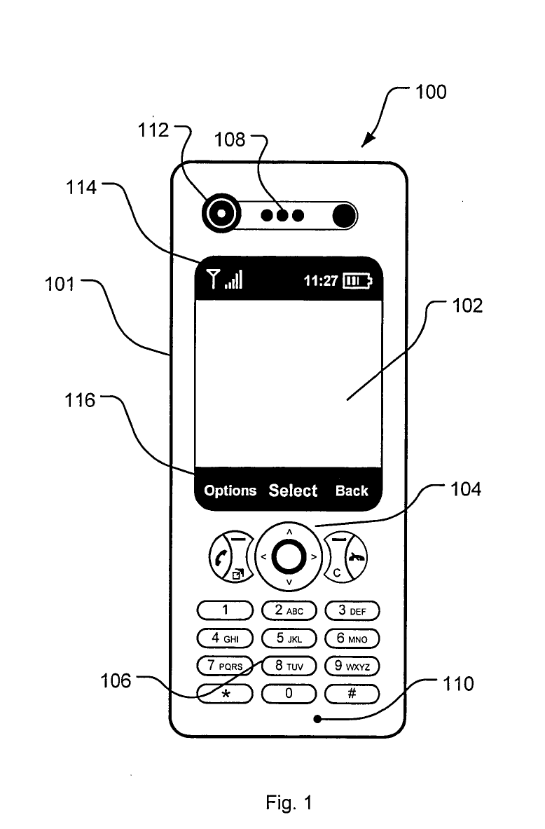

FIG. 1 show a mobile communication device 100 comprising a casing 101, a display area 102 and means 104 for navigating among items (not shown) displayed in the display area. The display area 102 may comprise a status indication area 114 and one or more softkey bars 116. The status indication area 114 may for example include symbols for indicating battery status, reception quality, speaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The mobile communication device 100 can also comprise other elements normally present in such a device, such as a keypad 106, a speaker 108, a microphone 110, a camera 112, a processor (not shown), a memory (not shown), one or more accelerometers (not shown), a vibration device (not shown), an AM/FM radio transmitter and receiver (not shown), a digital audio broadcast transmitter and receiver (not shown), etc. Several types of accessories may be connected to the mobile communication device 100.

One way of solving, or at least mitigate, the problems discussed in the background section is to when an event, incoming or outgoing, is detected gather user specific parameters which may be used to determine the mood of the user, and to create a unique communication signal, such as an audio signal, describing the user's mood. The unique communication signal may then be attached to incoming or outgoing (or both) communication events, thus communicating the current mood of the user to his or hers immediate surrounding and to recipients of an outgoing communication event (other users).

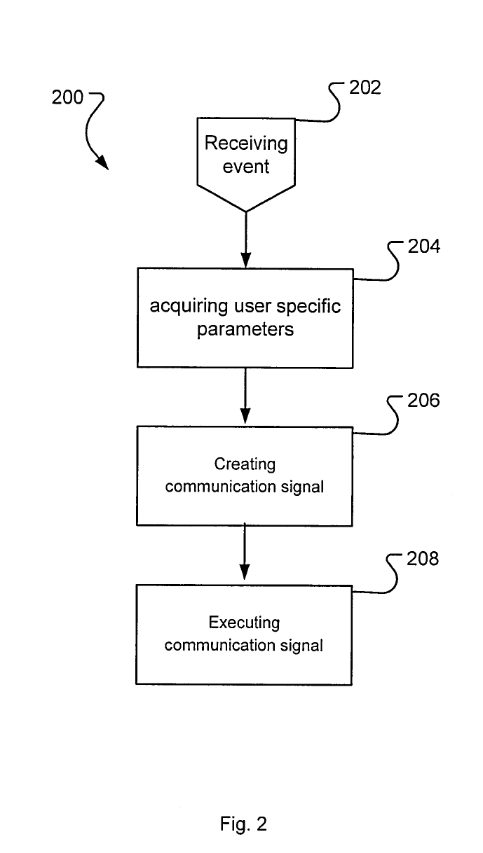

FIG. 2 shows a flowchart describing a process 200 for creating a unique mood based signal according to an embodiment of the present invention. The process of creating a mood based communication signal is initiated when an event 202 is received or detected. A typical event in a mobile communication device may for example be receiving an incoming call, a Short Message Service (SMS), a Multimedia Message Service (MMS), an e-mail, an incoming Wireless Local Area Network (WLAN) communication, a Bluetooth communication, a Near Field Communication message, a Wi-Fi message, an instant messaging message, or some other incoming wireless communication signal. An event may also be generated when a user-set alarm is triggered (going off), when a reminder (from the calendar or some other reminder generating application) is triggered, or some other event from an alert producing application (low battery indication, no reception indication, etc.) is generated.

When an event is received or detected 202, user specific parameters are acquired 204. User specific parameters may for instance be user-inputted parameters describing the user's current mood (e.g. user choose a mood from a list), parameters describing the user's physical state such as current activity level (e.g. heart rate, stride rate, accelerometer, etc.), parameters describing the user's psychological state (e.g. brain activity in certain parts of the user's brain), or be parameters gathered from other application in the mobile communication device which has been used by the user and which may describe the user's current mood (e.g. played songs, active playlist, current radio channel, current theme in device, the list of recently called persons, recent text communication with other users, internet browsing history, calendar date, current or visited locations, etc.). Which user specific parameters that should be acquired may be determined by the type of event that is detected, it may be factory preset, or it may be user-set.

The acquired user specific parameters 202 together with the received or detected event 202 may then be used as a basis for creating a unique communication signal 206. The created unique communication signal 206 may be in the form of one or several audio signals connected to one or more applications in the mobile communication device. The creation of the unique communication signal may be done in several different ways, such as by employing a special algorithm to interpret one or more of the acquired parameter(s), it may use one or more applications in the communication device to create the signal (e.g. SenseMe and MusicDJ), or it may make use of one or more pre-existing signals stored in the mobile communication device or in an external database. The unique communication signal may also be in the form of parameters which may be attached, influence, or alter applications in the mobile communication device to communicate the user or users (if the device is used by more than one user) present or past mood.

When a unique communication signal has been created 206 it will be executed 208 in some way or form in the mobile communication device. The unique signal may be applied to a specific function or application in the mobile communication device, or it may be communicated to other devices. For example, a created audio signal reflecting the user's current mood may replace the current ringtone in the mobile communication device.

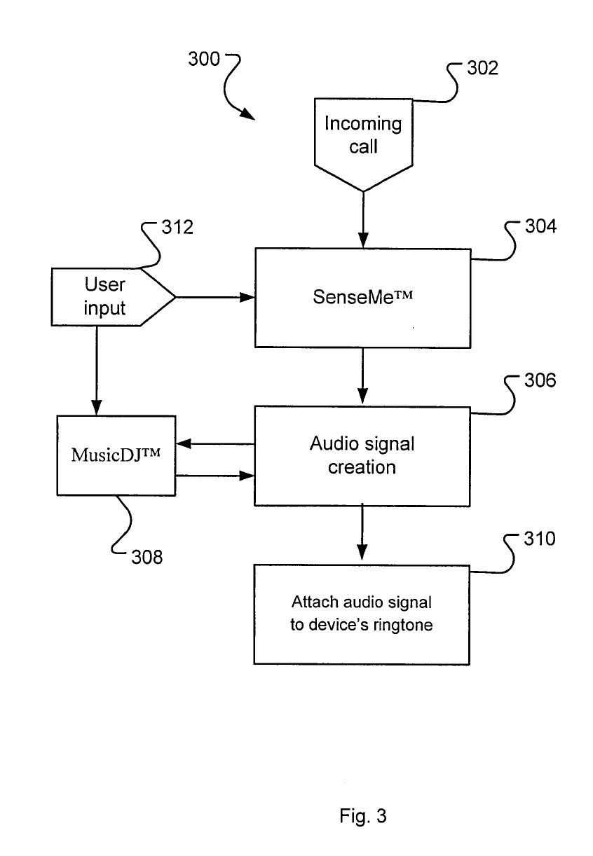

FIG. 3 shows a user example of the embodiment of the present invention described in conjunction with FIG. 2. This example describes, using a flowchart 300, how the invention may be used to change the ringtone in a mobile communication device depending on the user's mood. An incoming call is detected 302 by the mobile communication device. The incoming event triggers an existing application SenseMe 304 in the mobile communication device. The SenseMe application 304 is capable of determining the mood of the user depending on inputted parameters from the user. In this example the user has manually inputted 312 his or hers current mood to the SenseMe application 304 via the user interface in the communication device. The SenseMe application 304 generates a set of parameters describing the mood of the user and forwards them to the audio signal creation step 306. The audio signal creation step 306 receives the parameters, interprets them and sends instructions to the existing MusicDJ application 308 in the mobile communication device. MusicDJ is capable of creating and/or remixing an audio signal to reflect the current mood of the user. The MusicDJ 308 application receives the instructions and creates or remixes an audio signal which reflects the user's current mood. The user of the communication device may input 312 how the MusicDJ application should create or remix an audio signal. For instance, if the user is in a sad mood the user may set the MusicDJ application to either produce a “sad tune”, reflecting his or hers mood, or set it to produce a “happy tune” cheered up the user. The MusicDJ application 308 returns an audio signal to the audio signal creation step 306. The audio signal will then be attached 310 to the device's ringtone, meaning that the current ringtone of the mobile communication device is replaced with the created audio signal (ringtone). The new ringtone reflecting the user's mood will be played to alert the user to the incoming call. The process of creating a ringtone according to the example above may either be performed when an incoming call (event) is detected or when the user just wants to change the ringtone to reflect his/hers mood, thus generating a “change of ringtone event”.

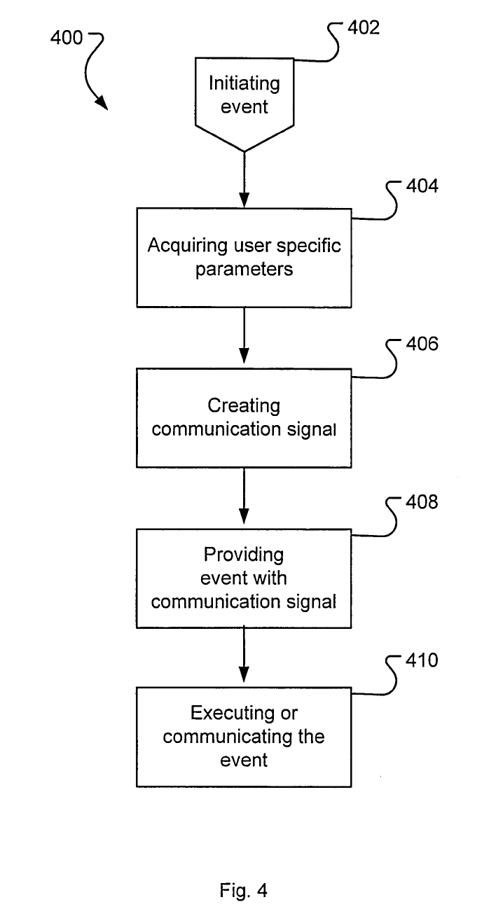

FIG. 4 shows a flowchart describing a process 400 for creating a mood dependent signal according to an embodiment of the present invention. The mood dependent signal creation processed is initiated when the user initiates an event 402 such as accessing an application where an audio signal may be used. A typical event in a mobile communication device may for example be creating a Short Message Service (SMS), a Multimedia Message Service (MMS), an e-mail, an Wireless Local Area Network (WLAN) communication, a Bluetooth communication, a Near Field Communication message, a Wi-Fi message, an instant messaging message, or some other wireless communication signal which an audio signal may be attached to. An event may also be the accessing of an application for setting; an alarm, a reminder (in a calendar or some other reminder generating application), or some other event from which an alert producing application (low battery indication, no reception indication, etc.) may be generated.

When an event is initiated 402, user specific parameters are acquired 404. As described above in conjunction with FIG. 2, user specific parameters may for instance be user-inputted parameters describing the user's current mood, parameters describing the user's physical state such as current activity level, parameters describing the user's psychological state, or be parameters gathered from other application in the mobile communication device which has been used by the user and which may describe the user's current mood. Which user specific parameters that should be acquired may be determined by the type of event generated, it may be factory preset, or it may be user-set.

The acquired user specific parameters 402 together with the initiated event 402 may then be used as a basis for creating a unique communication signal 406. The created unique communication signal 406 may be in the form of one or several audio signals connected to one or more applications in the mobile communication device. The creation of the unique communication signal may be done in several different ways, such as by employing a special algorithm to interpret the acquired parameter(s), it may use one or more applications in the communication device to create the signal, or it may make use of one or more pre-existing signals stored in the mobile communication device or in an external database. The unique communication signal may also be in the form of parameters which may be attached, influence, or alter applications in the mobile communication device to communicate the user or users (if the device is used by more than one user) present or past mood.

When a unique communication signal has been created 406 the initiated event or an application is provided 410 with the created communication signal. The created communication signal may for instance be attached or incorporated into the event in question. For instance, if the initiated event is ‘writing an MMS event’ the created communication signal, being for instance an audio signal, may be attached to the MMS.

In the next step the event with the provided communication signal is executed or communicated (transmitted) to one or more recipients. The recipient(s) of the executed or communicated event may hear the uniquely created communication signal being played when accessing or receiving the event.

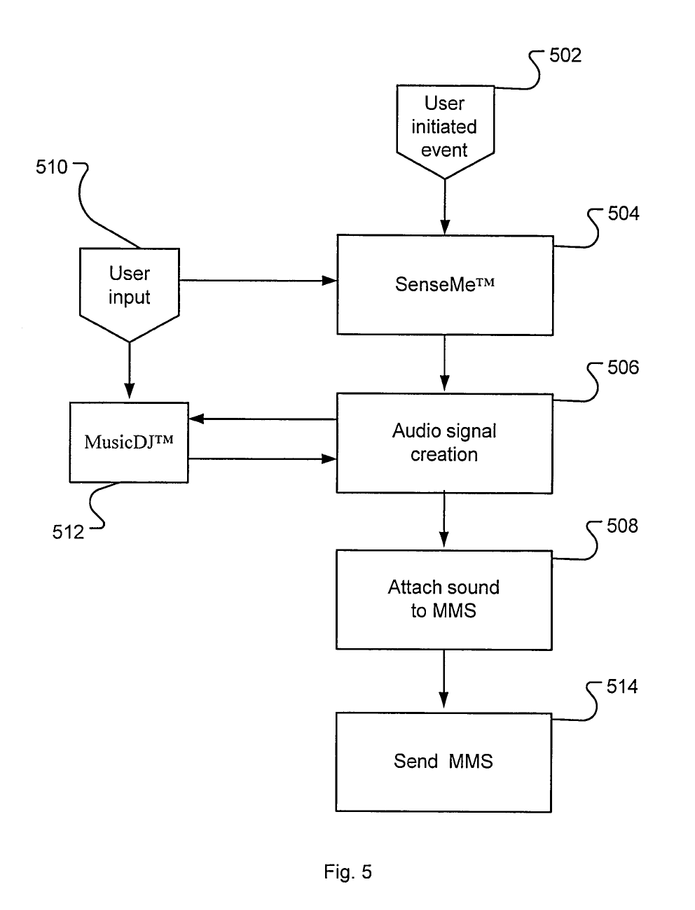

FIG. 5 shows a user example of the embodiment of the present invention described in conjunction with FIG. 4. This example shows a flowchart 400 describing how the invention may be used to attach a mood dependent audio signal to a MMS in a mobile communication device. A user initiated event is detected 302 when the user accesses the MMS application in the mobile communication device. The event triggers an existing application in the mobile communication device called SenseMe 504. The SenseMe application 504 is, as described above, capable of determining the mood of the user depending on inputted parameters. In this example the user has manually inputted 510 his or hers current mood to the SenseMe application 504 via a user interface in the communication device. The SenseMe application 504 generates a set of parameters describing the mood of the user and forwards them to the audio signal creation step 506. The audio signal creation step 506 receives the parameters from the SenseMe application step 504, interprets them, and sends instructions to the MusicDJ application 512 in the mobile communication device. MusicDJ is capable of creating and/or remixing an audio signal to reflect the current mood of the user. The MusicDJ 512 application receives the instructions and creates, or remixes, an audio signal which reflects the user's mood. The user of the communication device may determine may input 510 how the MusicDJ application may create or remix an audio signal. For instance, if the user is in a sad mood the user may set the MusicDJ application to either produce a “sad tune”, reflecting his or hers mood, or set it to produce a “happy tune” cheered up the user. The MusicDJ application 512 returns an audio signal to the audio signal creation step 506. The audio signal will then be attached 508 to the user's MMS. The MMS with the attached mood dependent audio signal will then be sent to the recipient(s) 514. When the recipients access the MMS the mood dependent audio signal will be played alerting the recipient(s) to the mood of the user. Thus, communicating the mood of the user to the recipient of the MMS.

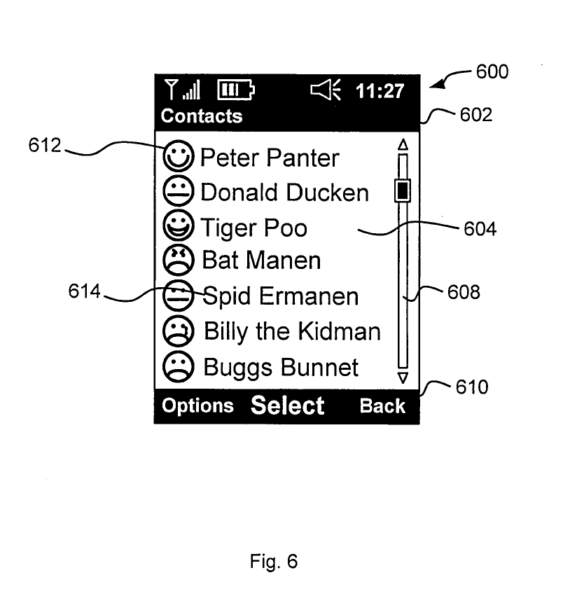

In another embodiment the user's mood is continuously monitored by sampling, by a user set or a factory preset time interval, the user specific parameters. At each time instance a unique mood dependant communication signal (or signals or theme) may be created in the same manner as described in conjunction with above embodiments. In one embodiment the unique mood dependant communication signal (or signals or theme) is executed in the phone changing different audio signals to reflect the user's current mood. In another embodiment a mood dependant audio signal and the current mood, hereinafter called mood state, of the user is communicated via a wireless communication technique to other user on a list, or generally broadcasted to users in the vicinity of the user. The received mood dependent audio signal and the mood state of the user may then be used to update, for example, the recipient's contacts list showing the current mood of each contact. FIG. 6 shows an example of a recipient's mobile communication device's display view 600. The display view in FIG. 6 comprising a general status indication section 602, a softkey bar 610 and a general display area 604. The general status indication section 602 may for instance include symbols for battery status, reception quality, speaker on/off, present mode, clock time, etc. The status indication section is not in any way limited to only include these symbols. Thus, other symbols in any shape, form or colour can occur. The softkey bar 606, situated at the bottom of the display view, is operable using the navigation means 104 mentioned in conjunction with FIG. 1. The functions of these softkeys are not limited by the functions indicated in the figure. The preferred function of the general display area 604, residing between the status indication section 602 at the top and the softkey bar 606 at the bottom, is to display information from running applications in the handheld communication apparatus. In our case the display area 604 shows a contacts list 614, displaying the names of all contacts 614 which mood is tracked. The current mood state of a user is in this example indicated as a ‘face’ 612 in the contacts list. The ‘face’ in the contacts list may express several different moods such as happy, sad, angry, or any expressions there between. Also, if a cursor is placed on a specific contact the unique mood depended signal, belonging to that contact, which was transmitted together with the mood state may be played. For instance, as can be seen in the figure ‘Peter Panter’ is indicated with a ‘smiley’, communicating that ‘Peter Panter’ is happy, while the user ‘Buggs Bunnet’ is indicated with a ‘sad face’ indicating that the user is sad. If a curser is placed over ‘Buggs Bunnet’ the received audio signal, being a sad tune in this case, from that user may be played. The list may be updated every time the contacts in the list transmit new mood states, or when the user of the contacts list requests a user on the list to transmit an update of his or hers mood state. In this way you are able to determine a user's mood before communicating with that user, which in certain situations may be very useful.

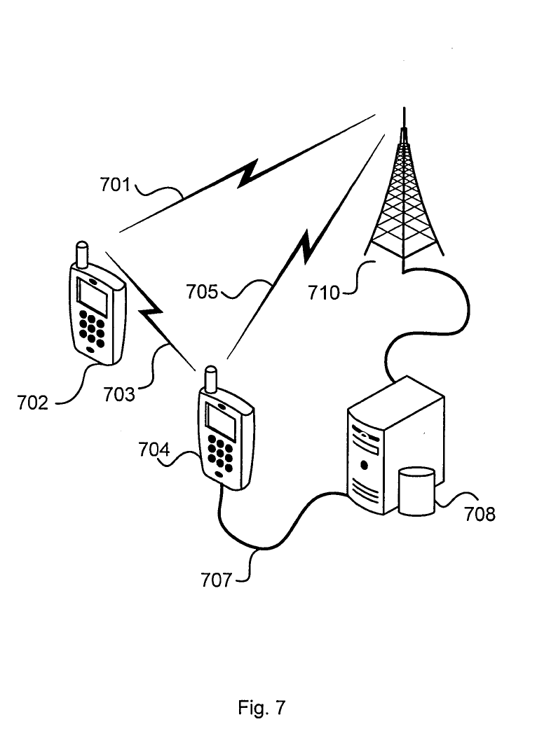

FIG. 7 shows a mobile communication device 704 communicating with another communication device 702 and an external server 708 according to an embodiment of the present invention. The mobile communication device 704 may be connected to an external server by wire 707 or by a wireless connection 705 communicating with a bas station system 710 connected to an external server 708. The server may in one embodiment collect the unique mood dependent communication information, such as audio signals and mood states, of all or a specific group of users. The mood dependent information may also, as discussed above, be directly shared between two communication devices 702, 704. Mood dependent information connected to a specific user may be accessed wirelessly directly from a user 703, by connecting to the database by a wire 707, or by connecting to the database via a wireless connection 705.

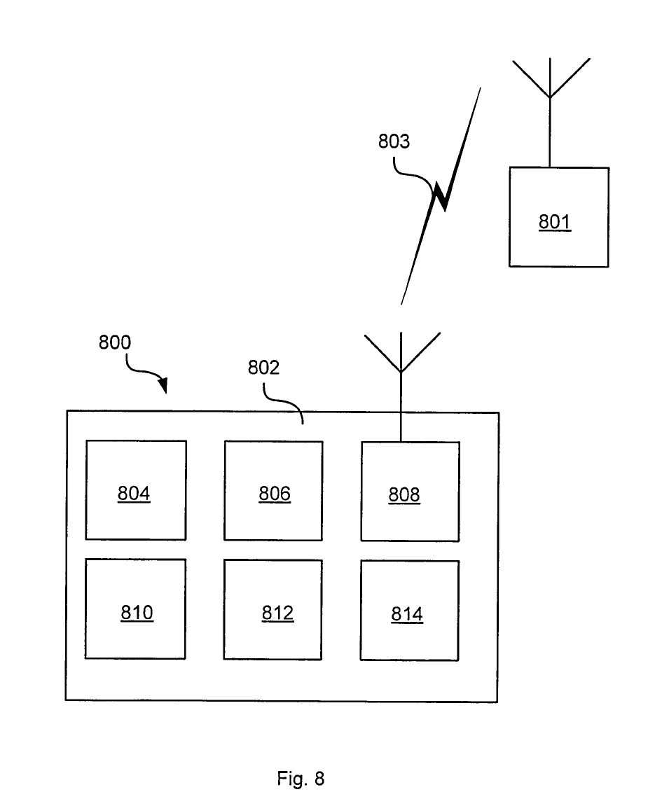

FIG. 8 shows a mobile communication device 800 having means 802 for performing the procedures described in above embodiments of the present invention. The mobile communication device may have means for receiving an incoming communication event 808, means for acquiring user specific parameters 804, means for creating a unique communication signal based on the user specific parameters and the communication event 806, and means for executing the unique communication signal to alert the user of the incoming event 810. The mobile communication device may also have the means for initiating an outgoing communication event 812, means for providing a communication event with the unique communication signal 814, and means for transmitting the communication event and the unique communication signal 808. The mobile communication device 800 may wirelessly 803 transmit 808 a communication event with a unique communication signal to another user or a base station 801. The communication event with the unique communication signal may have means for executing the unique communication signal at the user 801, thus alerting the recipient of the transmitted the outgoing communication event to the unique communication signal.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. Method for creating a unique communication signal in a communication device, comprising the steps of;
receiving an incoming communication event;
acquiring user specific parameters;
creating a unique communication signal based on said user specific parameters and said communication event;
executing said unique communication signal to alert the user of the incoming event.

2. The method according to claim 1, wherein said communication event is an incoming voice call.

3. The method according to claim 1, wherein said communication event is any communication event of the group comprising: incoming Short Message Service (SMS) event, incoming Multimedia Message Service (MMS) event, incoming e-mail event, incoming Bluetooth communication event, incoming near field communication event, incoming instant messenger event, and incoming data event.

4. The method according to claim 1, wherein user specific parameters are user-inputted parameters defining the mood of the user.

5. The method according to claim 1, wherein the user specific parameters are any parameters of the group comprising: parameters describing the user's physical state, parameters describing the user's mental state, parameters describing the user's activity level, and parameters coming from an application in the communication device.

6. The method according to claim 1, wherein the unique communication signal is a ringtone.

7. The method according to claim 1, wherein the unique communication signal is an audio signal.

8. The method according to claim 1, wherein the creation of said unique communications signal is further based on parameters from a SenseMe application and audio signals from a MusicDJ application.

9. The method according to claim 6, wherein executing involve playing said ringtone to the user.

10. The method according to claim 7, wherein executing involve playing said audio signal to the user.

11. The method according to claim 1, wherein executing further involves attaching said unique communication signal to an application in said communication device.

12. Method for creating a unique communication signal in a communication device, comprising the steps of;
initiating an outgoing communication event;
acquiring user specific parameters;
creating a unique communications signal based on said user specific parameters and said outgoing communication event;
providing said outgoing communication event with the unique communication signal;
transmitting said outgoing communication event and the unique communication signal; and
the communication signal is adapted to be executed for alerting a recipient of the transmitted the outgoing communication event.

13. The method according to claim 12, wherein the outgoing communication event is an outgoing Multimedia Message Service event.

14. The method according to claim 12, wherein the outgoing communication event is any communication event of the group comprising: outgoing Short Message Service event, outgoing e-mail event, outgoing Bluetooth communication event, outgoing near field communication event, outgoing instant messenger event, and outgoing data event.

15. The method according to claim 12, wherein the user specific parameters are any parameters of the group comprising: parameters describing the user's physical state, parameters describing the user's mental state, parameters describing the user's activity level, and parameters coming from an application in the communication device.

16. The method according to claim 12, wherein the creation of said unique communications signal is further based on parameters from a SenseMe application and audio signals from a MusicDJ application.

17. The method according to claim 12, wherein the unique communication signal is an audio signal.

18. The method according to claim 12, wherein the outgoing communication event is an outgoing Multimedia Message Service event.

19. The method according to claim 11, wherein the outgoing communication event is any of the outgoing communication events of the group comprising: outgoing Short Message Service event, outgoing e-mail event, outgoing Bluetooth communication event, outgoing near field communication event, outgoing instant messenger event, and outgoing data event.

20. The method according to claim 11, wherein said transmitting involves communicating wirelessly or by wire with a recipient.

21. The method according to claim 11, wherein the recipient is any recipient of the group comprising: a user of a mobile communication device, a group of users of mobile communication devices, and a computer terminal.

22. A communication device adapted to perform the steps of claim 1.

23. A communication device adapted to perform the steps of claim 12.
